(19) United States
(12) Patent Application Publication
(10) Pub. No.: US 2005/0073905 A1
(43) Pub. Date: Apr. 7, 2005

(54) Renewable drum mixer

(76) Inventors: Raymond E. Montgomery, Oklahoma City, OK (US); David W. Peal JR., Vancouver, WA (US)

Correspondence Address: DUNLAP, CODDING & ROGERS P.C., PO BOX 16370, OKLAHOMA CITY, OK, 73113, US

(21) Appl. No.: 10/678,384

(22) Filed: Oct. 3, 2003

(51) Int. Cl. B28C 5/46; B28C 5/18

(52) U.S. Cl. 366/25; 366/54

(57) ABSTRACT

A mixer for producing hot mix asphalt using both virgin aggregate and recycled material wherein the drum is divided into three sections, with the high wear section of the drum being replaceable to provide a drum mixer having a long service life.

### FIELD OF THE INVENTION

This invention relates to a hot mix asphalt drum mixer, and more particularly, but not by way of limitation, to a hot mix asphalt drum mixer having a high wear replaceable section.

### BACKGROUND OF THE INVENTION

In the hot mix asphalt drum mixer of the type shown in U.S. Pat. No. 5,558,432, recycled material is fed into the central portion of the drum mixer and is almost immediately combined with hot virgin aggregate. Portions of the drum adjacent to the recycled material aggregate inlet are subjected to substantial abrasive wear. Heretofore, such drum mixers were all of a unitary construction, such that when the abrasive wear on this one portion of the drum mixer becomes excessive, it was necessary to replace the entire drum mixer.

### BRIEF DESCRIPTION OF THE DRAWINGS

FIG. 1 is a longitudinal sectional view through a renewable drum mixer.

FIG. 2 is a side-elevational view of the portion of the drum mixer where recycled material is introduced into the drum mixer.

FIG. 3 is a cross-sectional view through that portion of the drum mixer shown in FIG. 2 to illustrate the internal construction of this portion of the drum mixer.

FIG. 4 is a partial end view of the mating ends of the second section 14 and the intermediate section 16.

FIG. 5 is a partial end view of the mating ends of the first section 12 and the intermediate section 16.

FIG. 6 is an enlarged cross-sectional view taken along the lines 6-6 of both FIGS. 4 and 5.

FIG. 7 is an enlarged cross-sectional view taken along the lines 7-7 of both FIGS. 4 and 5.

FIG. 8 is a longitudinal sectional view through a second embodiment of a renewable drum mixer.

### DETAILED DESCRIPTION OF THE DRAWINGS

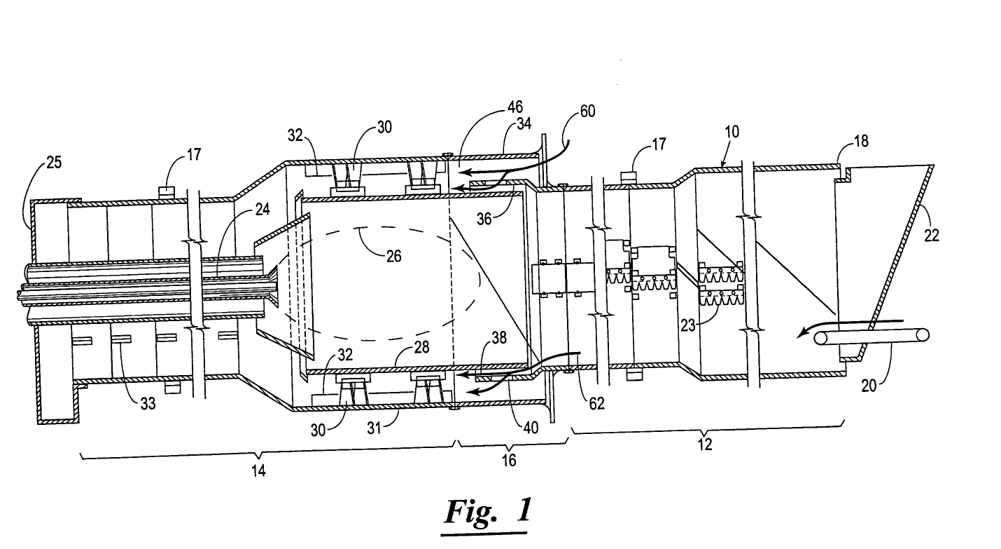

Referring to the drawings in detail, and particularly FIG. 1, reference number 10 generally designates an elongated drum which is constructed in three separable sections, namely a first section indicated by the bracket 12, a second section indicated by the bracket 14 and an intermediate section indicated by the bracket 16. The drum 10 is supported for rotation by suitable trunnions 17 in the usual fashion. The free end 18 of the first drum section 12 has a virgin aggregate feeder 20 for feeding virgin aggregate into the end 18 of the drum 10, as well as an exhaust duct 22, by means of which exhaust gases are removed from the drum 10 during operation. Suitable flighting 23 is provided along the interior of the first drum section 10 to move the virgin aggregate toward the intermediate section 16 of the drum in the usual fashion.

The second section 14 of the drum 10 is provided with the usual burner assembly 24 which extends through the discharge end 25 of the drum 10 and produces a flame 26 and a stream of hot gases flowing through the portion of the drum section 14 adjacent to the intermediate section 16; through the section 16 and the section 12 to the exhaust duct 22. A tubular heat shield 28 is supported in the drum section 14 extending essentially from the burner 24 through the end of the drum section 14 and through a substantial portion of the intermediate drum section 16. The heat shield 28 is supported by supports 30 between the outer wall 31 of the drum section 14 and the heat shield 28 is constructed in a suitable manner to minimize the obstruction of the flow of aggregate through that portion of the drum section 14 adjacent to the intermediate drum section 16 which flows around the heat shield 28. Also, suitable scoops or flights 32 are provided along the outer wall 31 to move the aggregate along the heat shield 28 and around the burner assembly 24 as will be set forth below. It will also be noted that suitable flighting 33 is provided in the downstream end portion of the drum section 14 to move the aggregate toward the discharge end 25 of the drum 10.

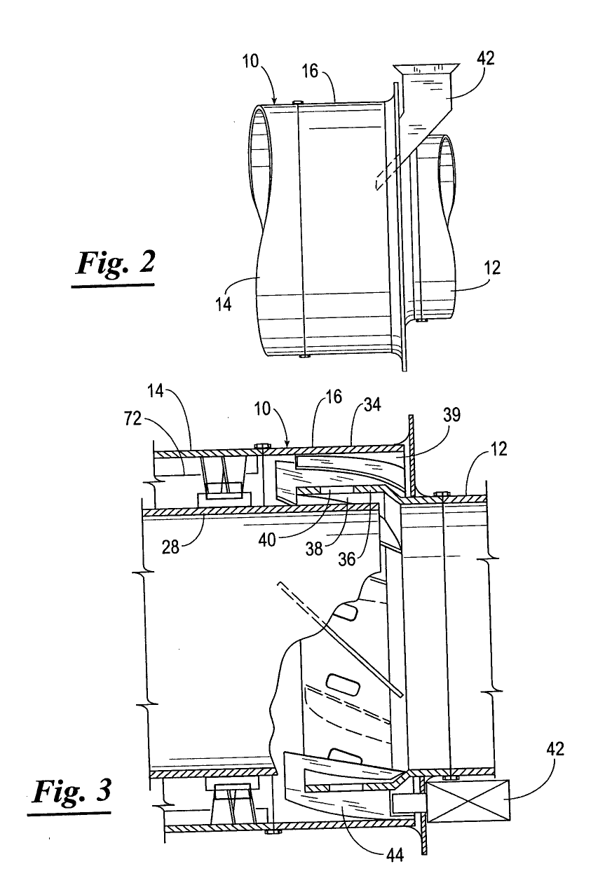

The intermediate section 16 of the drum 10 is shown enlarged in FIGS. 2 and 3. The intermediate drum section 16 comprises an outer drum shell 34 conforming in size with the drum shell 31 of the second drum section 14. The intermediate drum section 16 also includes a cylindrical shell or wall 36, a portion of which surrounds the adjacent end portion of the heat shield 28 and provides an annular space 38 between the heat shield 28 and the adjacent portion of the shell 36. The portion of the shell 36 which surrounds the heat shield 28 also has a plurality of apertures 40 for the flow of aggregate as will be set forth hereinafter. The end portion of the shell 36 adjacent the first drum section 12 is reduced in diameter to conform to the diameter of the drum section 12. A plurality of kicker flights 44 extend between the outer wall 34 and the inner shell 36 of the intermediate section 16 to hold those parts in assembly and to urge the virgin aggregate and recycled material downstream as will be set forth hereinafter. A recycled material chute 42 is mounted on the intermediate drum section 16 to feed recycled material into the annular space 39 between the drum shells 34 and 36 in the same manner as set forth in the previously mentioned U.S. Pat. No. 5,558,432.

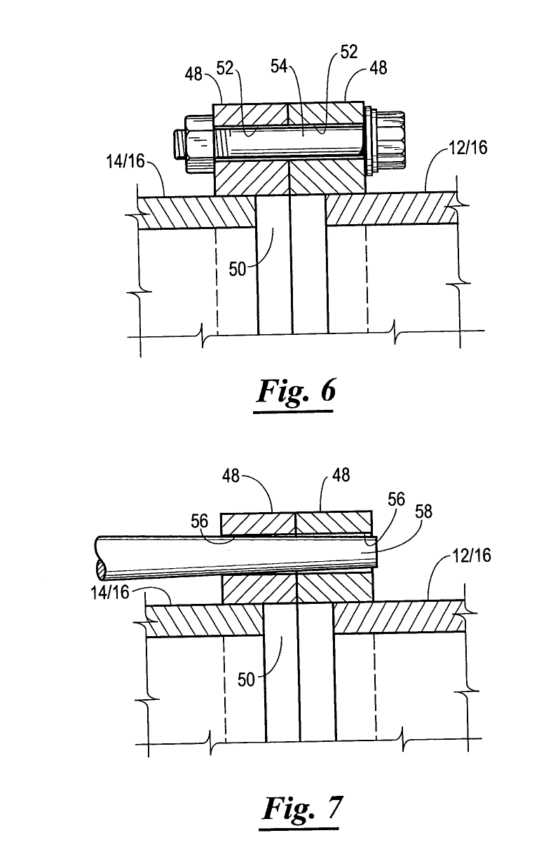

As shown in both FIGS. 6 and 7, the mating ends of the drum sections 12 and 16 and the mating ends of the drum sections 14 and 16 each have a mating ring or flange 48 secured there around, as by welding, and each pair of flanges 48 are in abutting relationship as shown in both FIGS. 6 and 7. When assembled, there is a rather small space 50 between the adjacent ends of the drum sections. A plurality of mating apertures 52 are provided in circumferentially spaced relation around the rings or flanges 48. The majority of these apertures 52 receive connecting bolts 54 for rigidly securing the adjacent drum sections together.

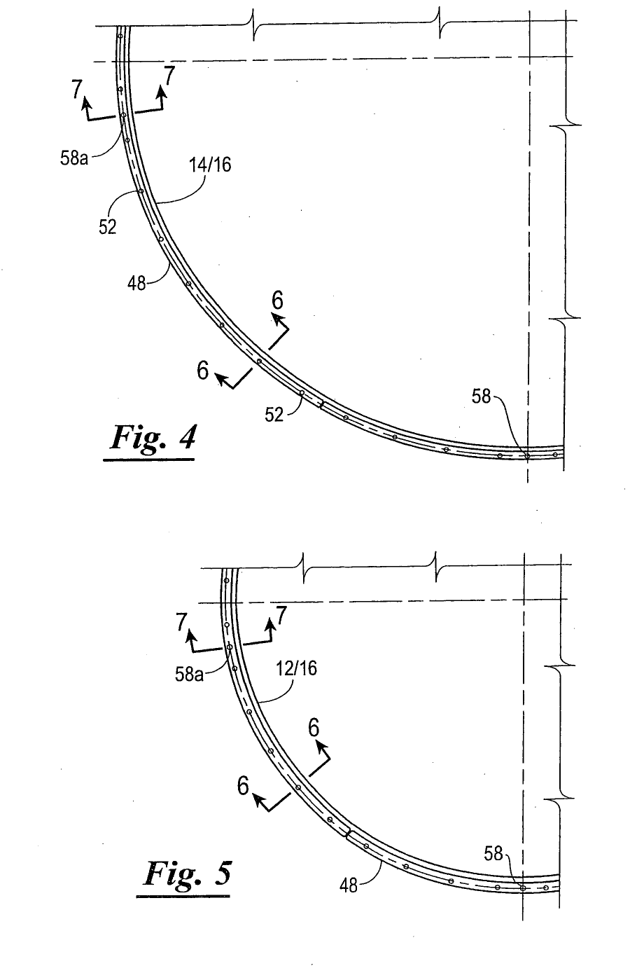

Each mating pair of rings or flanges 48 also have four mating apertures 56 (FIGS. 4, 5 and 7) which temporarily receive drift pins 58 to provide a means by which the mating drum sections, when assembled in a complete drum 10 will be properly circumferentially aligned. As shown in FIGS. 4 and 5, the drift pins 58 are arranged in such a manner that three of the drift pins 58 are spaced 90° apart, but one of the drift pins 58a is not at 90° from the adjacent drift pins. Although only two drift pins 58 and 58a are shown in FIGS. 4 and 5, it will be understood that there are two more drift pins 58 spaced 90° apart. With this arrangement, the adjacent mating sections of the drum 10 will be properly circumferentially oriented and after some of the bolts 54 have been installed during assembly, the drift pins 58 and 58a are removed and replaced with bolts 54.

### Operation

When the drum 10 is used to produce hot mix asphalt, the drum 10 is rotated and the burner assembly 24 is placed in operation to provide the flame 26. The flame 26 heats the heat shield 28 and the annular space 46 between the heat shield 28 and the mating portion of the outer wall 34 of the drum section 14 and the drum section 16, as well as producing a flow of hot gases through the intermediate drum section 16 and first drum section 12 to heat the virgin aggregate being introduced by the feeder 20, as well as the recycled asphaltic material being introduced through the feeder 42.

The recycled material is introduced into the annular space 46 as indicated by the arrows 60 in FIG. 1. The majority of the recycled material is directed downstream through the annular space 46 to be joined with the virgin aggregate being transferred from the first drum section 12 into the intermediate drum section 16 as indicated by the arrow 62. A minor portion of the recycled material may flow through the apertures 40 into the annular space 38, and a minor portion of the virgin aggregate will flow radially outwardly through the apertures 40 into the annular space 46 to combine with the recycled material. As the combination of virgin aggregate and recycled material are moved downstream around the heat shield 28, the recycled material and the virgin aggregate will start being mixed, as well as heated. As the recycled material and virgin aggregate leave the annular space 46, they move radially inwardly around the burner 24 and are thoroughly mixed in the downstream end portion of the drum section 14 before being discharged from the end 25 as hot mix asphalt.

Upon the introduction of the recycled material and virgin aggregate into the annular spaces 38 and 46, the intermediate section 16 of the drum 10, and particularly the shell 36, are subjected to a relatively high rate of wear. When such wear becomes excessive, the worn intermediate drum section 16 can be easily replaced with a new intermediate drum section 16; whereupon the renewed drum 10 can be used for a period of time at least essentially the same length of time as the original new drum 10.

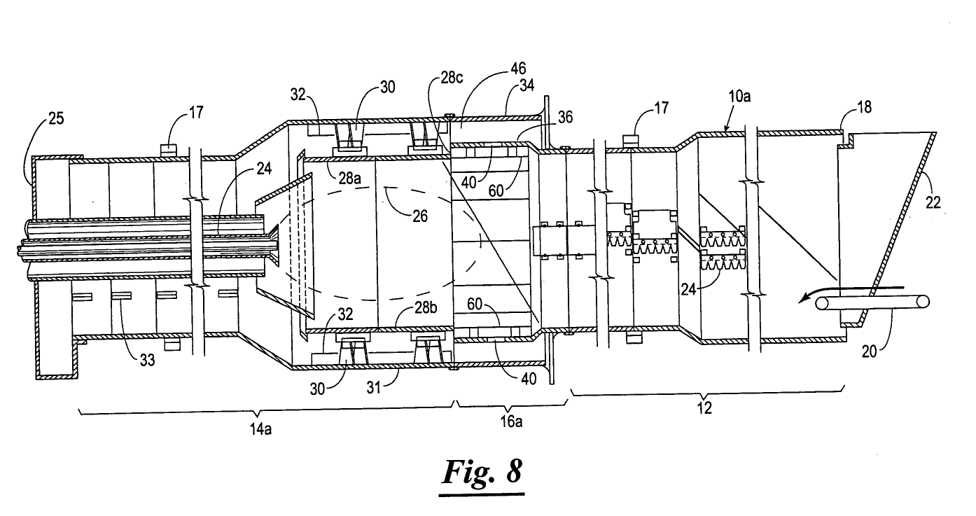

A modified drum mixer is shown in FIG. 8. This drum mixer includes an elongated drum 10a which utilizes the same first drum section 12, but modified second drum section 14a and modified intermediate drum section 16a.

The modified second drum section 14a is the same as the original drum section 14 with the following changes. The heat shield 28 is formed in two sections 28a and 28b and the length of the modified heat shield is shortened, such that the entire heat shield 28 is contained within the second drum section 14a. Also, the two heat shield sections 28a and 28b may be formed of two different materials, such as one section 28a being formed of carbon steel and the other section 28b, being the higher wear section, being formed of stainless steel.

The modified intermediate section 16a retains the outter shell 34 and inner shell 36 to form the annulus 46 into which the recycled asphaltic material is moved. However, the inner shell 36 is of a length to terminate even with the end 28c of the heat shield 28, such that the recycled asphaltic material will move directly from around the shell 36 into the annulus around the heat shield 28. Also, insulating flights 60 are mounted around the interior of the shell 36 to receive the virgin aggregate discharging from the first drum section 12 to shield the shell 36 from heat and prevent the virgin aggregate from dropping into the flame 26 while the virgin aggregate is moving toward the annulus around the heat shield 28.

The modified drum 10a facilitates the replacement of the intermediate section 16a, in that the intermediate drum section 16a can be removed and replaced without having to move either the section 12 or the section 14a. Also, the higher wear portion 28b of the heat shield 28 can be replaced without the need to replace the entire heat shield 28 when wear occurs.

Changes may be made in the combination and arrangements of parts or elements as heretofore set forth in the specification and shown in the drawings without departing from the spirit and scope of the invention as defined in the following claims:

1. A drum mixer for producing hot mix asphalt from virgin aggregate and recycled asphaltic material, comprising:
an elongated drum having a first end and a second end constructed in three separable sections lengthwise of the drum consisting of a first section extending from the first end of the drum, a second section extending from the second end of the drum and an intermediate section between the first and second sections;
a virgin aggregate entry in the first section of the drum near the first end of the drum;
flighting in the first section of the drum extending from the first end of the drum for moving the virgin aggregate through the first section of the drum into the intermediate section of the drum;
a burner extending into the second end of the drum for producing a flame in the second section of the drum and hot gases flowing counter to the flow of the virgin aggregate from the second section of the drum through the intermediate section and the first section of the drum; and
a recycled asphaltic material entry in the intermediate section of the drum.

2. A drum mixer as defined in claim 1 characterized further to include;
a cylindrical wall in the intermediate section of the drum over which the recycled asphaltic material moves upon entry into the drum.

3. A drum mixer as defined in claim 2 characterized further to include;
flighting around said cylindrical wall for moving the recycled asphaltic material toward the second section of the drum.

4. A drum mixer as defined in claim 1 characterized further to include mating flanges around the mating ends of the first section and the intermediate section, and around the mating ends of the second section and the intermediate section.

5. A drum mixer as defined in claim 4 characterized further to include four alignment apertures in each of said flanges spaced other than 90° apart, said apertures on adjacent ends of said sections being in alignment when said sections are aligned circumferentially in a specified manner, whereby said sections may be held in correct circumferential alignment with drift pins during assembly.

6. A drum mixer as defined in claim 1 characterized further to include;
a tubular heat shield having a first end and a second end supported concentrically in the second section of the drum in a position to surround the flame produced by the burner; wherein;
the heat shield is supported in a position whereby the virgin aggregate and recycled asphaltic material move around the heat shield toward the second end of the drum.

7. A drum mixer as defined in claim 6, wherein;
the heat shield is supported in the second section of the drum whereby the second end of the heat shield facing the intermediate section of the drum terminates at the end of the second section of the drum nearer to the intermediate section of the drum.

8. A drum mixer as defined in claim 7 wherein the heat shield is formed in the two sections supported in end-to-end relation.

9. A drum mixer as defined in claim 8 wherein the two sections of the heat shield are formed of different materials.
